(19) United States
(12) Patent Application Publication
(10) Pub. No.: US 2026/0089411 A1
(43) Pub. Date: Mar. 26, 2026

(54) DETECTION DEVICE

(71) Applicant: Japan Display Inc., Tokyo (JP)

(72) Inventors: Gen KOIDE, Tokyo (JP); Takanori TSUNASHIMA, Tokyo (JP)

(21) Appl. No.: 19/336,959

(22) Filed: Sep. 23, 2025

(30) Foreign Application Priority Data
Sep. 25, 2024 (JP) 2024-166049

(51) Int. Cl. H04N 25/76; H04N 23/55; H04N 23/56; H04N 25/78

(52) U.S. Cl. CPC H04N 25/7795; H04N 23/55; H04N 23/56; H04N 25/78

(57) ABSTRACT

According to an aspect, a detection device includes: a sensor panel including a detection area provided with optical sensors and a drive circuit; a light source; and a control circuit configured to control the sensor panel and the light source and repeat an imaging period and a waiting period. The drive circuit includes a buffer circuit including a CMOS inverter circuit having a p-type transistor and an n-type transistor coupled in series between a first potential and a second potential lower than the first potential and is configured to supply drive signals to the optical sensors via the buffer circuit during the imaging period. The control circuit is configured to control an output potential of the buffer circuit to be the first potential during a first period in the waiting period, and stop power supply to the buffer circuit during a second period in the waiting period.

### CROSS-REFERENCE TO RELATED APPLICATION

This application claims the benefit of priority from Japanese Patent Application No. 2024-166049 filed on September 25, 2024, the entire contents of which are incorporated herein by reference.

### BACKGROUND

### 1. Technical Field

What is disclosed herein relates to a detection device.

### 2. Description of the Related Art

Methods have been developed for acquiring images of a culture medium (e.g., agar) in a culture vessel and a colony of microorganisms such as bacteria (object to be detected) on the culture medium over time with a lens-less imaging system using a photosensor (for example, Japanese Patent Application Laid-open Publication No. 2018-033430). In such a lens-less imaging system, a growth process of the colony of the microorganisms is acquired over time by capturing colony formation images of the microorganisms at intervals of imaging periods with a predetermined waiting period interposed therebetween.

A drive circuit that drives a plurality of optical sensors including photodiodes is maintained in a constant state during the waiting period. At this time, some of thin-film transistors (TFTs) included in the drive circuit are maintained in an on state, so that a threshold voltage (Vth) shifts to the negative side (hereinafter, called "Vth shift"), which may deteriorate current-voltage characteristics and degrade reliability.

For the foregoing reasons, there is a need for a detection device capable of inhibiting acceleration of deterioration of the characteristics due to the Vth shift of the thin-film transistors included in the drive circuit.

### SUMMARY

According to an aspect, a detection device includes: a sensor panel including a detection area in which a plurality of optical sensors are arranged in a planar configuration and a drive circuit configured to drive the optical sensors; a light source configured to emit light to the detection area; and a control circuit configured to control the sensor panel and the light source to acquire detection values of the optical sensors, and repeat, at intervals of a predetermined period, an imaging period during which an image of an object to be detected located in the detection area is captured and a waiting period during which the image of the object to be detected is not captured. The drive circuit includes a buffer circuit including a complementary metal-oxide-semiconductor (CMOS) inverter circuit in which a p-type transistor and an n-type transistor are coupled in series between a first potential and a second potential lower than the first potential, and is configured to supply drive signals to the optical sensors via the buffer circuit during the imaging period. The control circuit is configured to control an output potential of the buffer circuit to be the first potential during a first period in the waiting period, and stop power supply to the buffer circuit during a second period different from the first period in the waiting period.

According to an aspect, a detection device includes: a sensor panel including a detection area in which a plurality of optical sensors are arranged in a planar configuration and a drive circuit configured to drive the optical sensors; a light source configured to emit light to the detection area; and a control circuit configured to control the sensor panel and the light source to acquire detection values of the optical sensors, and repeat, at intervals of a predetermined period, an imaging period during which an image of an object to be detected located in the detection area is captured and a waiting period during which the image of the object to be detected is not captured. The drive circuit includes a buffer circuit including a complementary metal-oxide-semiconductor (CMOS) inverter circuit in which a p-type transistor and an n-type transistor are coupled in series between a first potential and a second potential lower than the first potential, and is configured to supply drive signals to the optical sensors via the buffer circuit during the imaging period. The control circuit is configured to control an output potential of the buffer circuit to be the first potential during a first period in the waiting period, and control the output potential of the buffer circuit to be the second potential during a second period different from the first period in the waiting period.

According to an aspect, a detection device includes: a sensor panel including a detection area in which a plurality of optical sensors are arranged in a planar configuration and a drive circuit configured to drive the optical sensors; a light source configured to emit light to the detection area; and a control circuit configured to control the sensor panel and the light source to acquire detection values of the optical sensors, and repeat, at intervals of a predetermined period, an imaging period during which an image of an object to be detected located in the detection area is captured and a waiting period during which the image of the object to be detected is not captured. The drive circuit includes a buffer circuit including a complementary metal-oxide-semiconductor (CMOS) inverter circuit in which a p-type transistor and an n-type transistor are coupled in series between a first potential and a second potential lower than the first potential, and is configured to supply drive signals to the optical sensors via the buffer circuit during the imaging period. The control circuit is configured to stop power supply to the buffer circuit during the waiting period.

### BRIEF DESCRIPTION OF THE DRAWINGS

FIG. 1 is a diagram illustrating a main configuration of a detection device;

FIG. 2 is a diagram illustrating a configuration example of a detection area and a wiring area;

FIG. 3 is a circuit diagram illustrating a circuit configuration of an optical sensor;

FIG. 4 is a schematic view illustrating a positional relation between the main configuration of the detection device and an object to be detected;

FIG. 5 is a circuit diagram illustrating an example of internal components of a first drive circuit and a second drive circuit;

FIG. 6 is a block diagram illustrating a configuration example of a drive circuit according to an embodiment of the present disclosure;

FIG. 7 is a timing diagram illustrating a first example of timing control of an imaging period and a waiting period of the detection device according to the embodiment;

FIG. 8 is a conceptual chart illustrating logic values of respective parts of a buffer circuit in the first example of the timing control illustrated in FIG. 7;

FIG. 9 is a timing diagram illustrating a second example of the timing control of the imaging period and the waiting period of the detection device according to the embodiment;

FIG. 10 is a timing diagram illustrating a third example of the timing control of the imaging period and the waiting period of the detection device according to the embodiment;

FIG. 11 is a conceptual chart illustrating the logic values of the respective parts of the buffer circuit in the third example of the timing control illustrated in FIG. 10;

FIG. 12 is a timing diagram illustrating a fourth example of the timing control of the imaging period and the waiting period of the detection device according to the embodiment; and

FIG. 13 is a timing diagram illustrating a fifth example of the timing control of the imaging period and the waiting period of the detection device according to the embodiment.

### DETAILED DESCRIPTION

The following describes an embodiment of the present disclosure with reference to the drawings. What is disclosed herein is merely an example, and the present disclosure naturally encompasses appropriate modifications easily conceivable by those skilled in the art while maintaining the gist of the present disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same element as that illustrated in a drawing that has already been discussed is denoted by the same reference numeral through the description and the drawings, and detailed description thereof may not be repeated where appropriate.

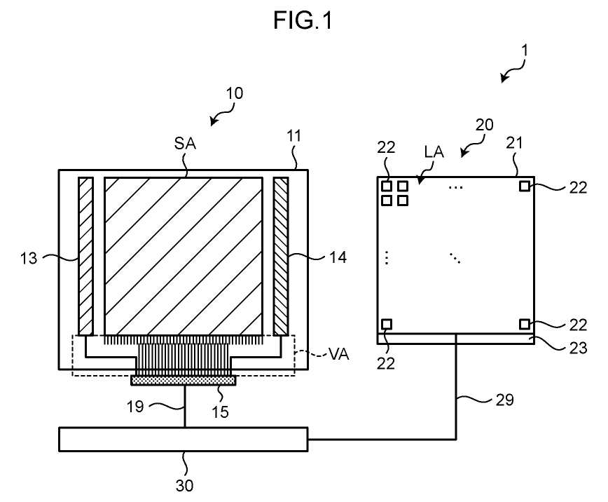

FIG. 1 is a diagram illustrating a main configuration of a detection device 1. The detection device 1 includes a sensor panel 10, a light source panel 20, and a control circuit 30. The sensor panel 10 and the light source panel 20 of the detection device 1 are coupled to the control circuit 30.

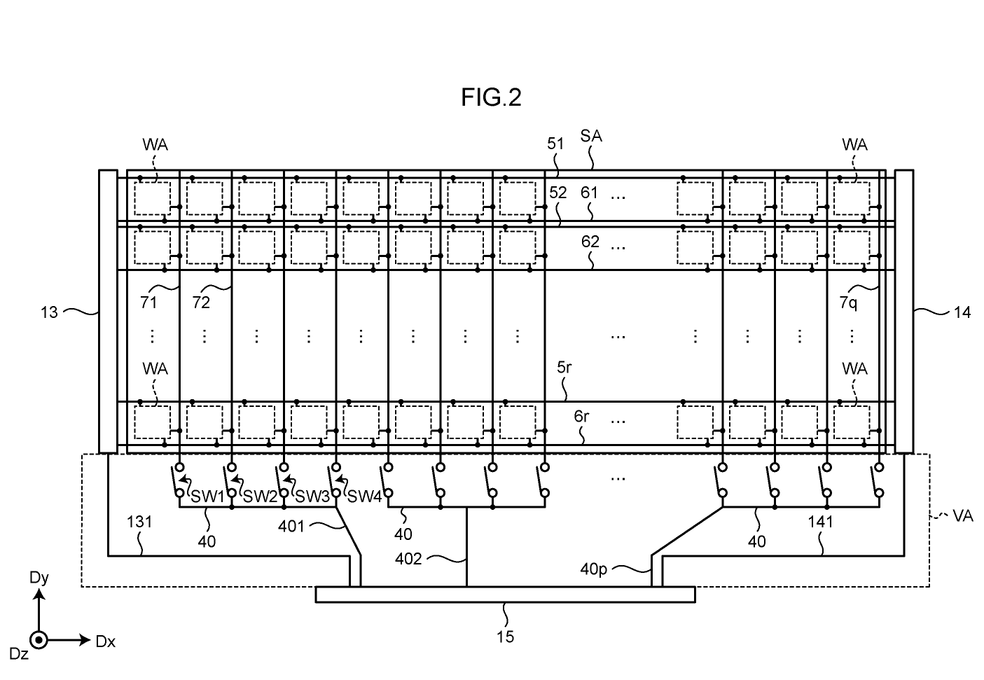

The sensor panel 10 is provided with a detection area SA (refer to FIG. 2) on a substrate 11. A first drive circuit 13, a second drive circuit 14, and a wiring area VA are mounted on the substrate 11. Components on the detection area SA, the first drive circuit 13, and the second drive circuit 14 are coupled to a detection circuit 15 via the wiring area VA.

The light source panel 20 has a light-emitting area LA that emits light to the detection area SA. The light source panel 20 is provided with a light source 22 on a substrate 21. The light source 22 includes a light-emitting element such as a light-emitting diode (LED), and is provided in the light-emitting area LA. In the example illustrated in FIG. 1, a plurality of the light sources 22 are arranged in a matrix having a row-column configuration on the substrate 21.

The light source panel 20 is provided with a light source drive circuit 23. Under the control of the control circuit 30, the light source drive circuit 23 controls turning on and off each of the light sources 22 and the luminance thereof when being turned on. The light sources 22 may be provided so as to be individually controllable in light emission or may be provided so as to emit light all together.

The control circuit 30 performs various types of control related to the operation of the detection device 1. Specifically, the control circuit 30 is a circuit, such as a field-programmable gate array (FPGA) or an application-specific integrated circuit (ASIC) that can implement a plurality of functions. The control circuit 30 is coupled to the detection circuit 15 via wiring 19 and obtains an output from the detection circuit 15. The control circuit 30 is coupled to the light source drive circuit 23 via wiring 29 and performs processing related to the lighting of the light sources 22, such as determination of lighting patterns of the light sources 22.

The control circuit 30 also performs processing related to detection of a colony in an object to be detected SUB (refer to FIG. 4). This processing will be described later.

Although not illustrated in the drawings, the detection device 1 includes an analog-to-digital conversion circuit, a digital-to-analog conversion circuit, and other components. The analog-to-digital conversion circuit allows an output from an optical sensor WA (refer to FIG. 2) transmitted through the detection circuit 15 to be handled by arithmetic processing by the control circuit 30. The digital-to-analog conversion circuit makes digital signals generated by the arithmetic processing of the control circuit 30 usable for controlling operations of the sensor panel 10 and the light source panel 20. These circuits may be included, for example, in part or in whole in the control circuit 30, may be functions performed by circuits mounted on flexible printed circuits (FPCs) provided with the wiring 19 and/or the wiring 29, or may be implemented in other ways in the detection device 1.

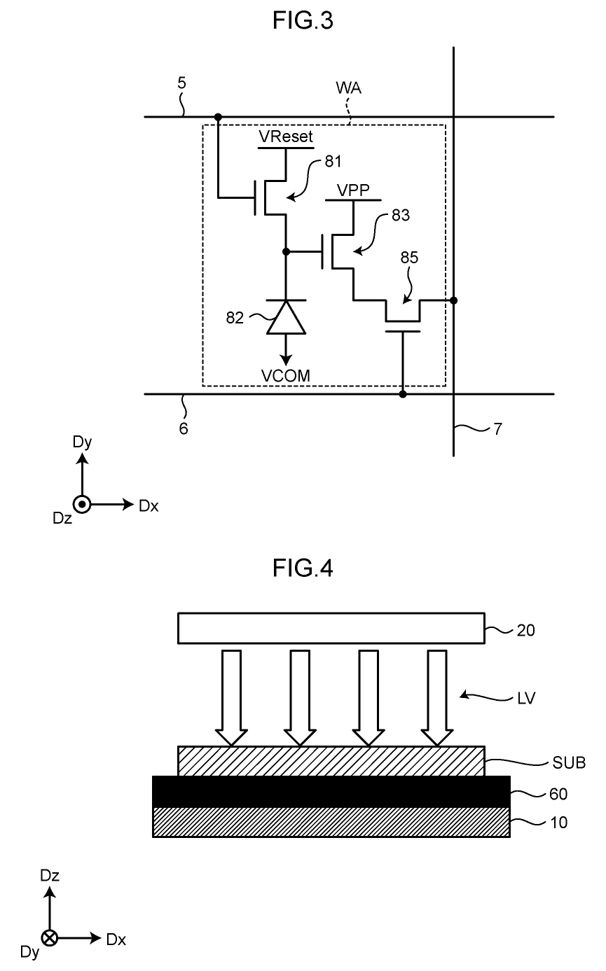

FIG. 2 is a diagram illustrating a configuration example of the detection area SA and the wiring area VA. A plurality of the optical sensors WA (FIG. 3) are provided in the detection area SA. In the embodiment, as illustrated in FIG. 2, the optical sensors WA are arranged in a matrix having a row-column configuration along a first direction Dx and a second direction Dy. The first direction Dx is orthogonal to the second direction Dy. In the following description, the term "third direction Dz" refers to a direction orthogonal to the first direction Dx and the second direction Dy.

The first drive circuit 13 is coupled to reset control scan lines 51, 52, ..., 5r. Hereinafter, the term "reset control scan line 5" refers to any one of the reset control scan lines 51, 52, ..., 5r. The reset control scan line 5 is wiring along the first direction Dx. In the example illustrated in FIG. 2, r reset control scan lines 5 are arranged in the second direction Dy. r is a natural number equal to or larger than 2. The r reset control scan lines 5 are each coupled, at one end in the first direction Dx, to the first drive circuit 13.

The second drive circuit 14 is coupled to readout control scan lines 61, 62, ..., 6r. Hereinafter, the term "readout control scan line 6" refers to any one of the readout control scan lines 61, 62, ..., 6r. The readout control scan line 6 is wiring along the first direction Dx. In the example illustrated in FIG. 2, r readout control scan lines 6 are arranged in the second direction Dy. The r readout control scan lines 6 are each coupled, at the other end in the first direction Dx, to the second drive circuit 14.

As illustrated in FIG. 2, the reset control scan lines 5 and the readout control scan lines 6 are alternately arranged in the second direction Dy in the detection area SA. The first drive circuit 13 and the second drive circuit 14 illustrated in FIGS. 1 and 2 are arranged at locations facing each other with the detection area SA interposed therebetween, but the layout of the first drive circuit 13 and the second drive circuit 14 is not limited to this layout and can be changed as appropriate.

Signal lines 71, 72, ..., 7q are also provided in the detection area SA. Hereinafter, the term "signal line 7" refers to any one of the signal lines 71, 72, ..., 7q. The signal line 7 is wiring along the second direction Dy.

In the example illustrated in FIG. 2, q signal lines 7 are arranged in the first direction Dx. q is a natural number equal to or larger than 2. The q signal lines 7 are each coupled, at one end in the second direction Dy, to one of a plurality of switches (for example, switch SW1, SW2, SW3, or SW4) included in a multiplexer 40.

The multiplexer 40 is provided in the wiring area VA. The multiplexer 40 includes a plurality of switches. In the example illustrated in FIG. 2, the switches SW1, SW2, SW3, and SW4 are illustrated as the switches. The switches included in one multiplexer 40 are turned on (conducting state) at different times from one another. During a period when one of the switches included in one multiplexer 40 is on (conducting state), the other switches are off (non-conducting state). The number of the multiplexers 40 depends on the number (q) of the signal lines 7. When the number of the switches is p, q/p is sufficient as the number of the multiplexers 40. When more than one multiplexer 40 are provided, each of the multiplexers 40 is coupled to the detection circuit 15 via an individual one of wiring lines 401, 402, ..., 40p.

The coupling between the signal lines 7 and the detection circuit 15 via the multiplexer 40 is merely exemplary and is not limited to this example. The signal lines 7 may be individually directly coupled to the detection circuit 15 in the wiring area VA. In the wiring area VA, the first drive circuit 13 is coupled to the detection circuit 15 via wiring 131. In the wiring area VA, the second drive circuit 14 is coupled to the detection circuit 15 via wiring 141.

In the detection of light by a photodiode 82 (refer to FIG. 3) provided in the optical sensor WA, the detection circuit 15 controls operation timing of the first drive circuit 13 and the second drive circuit 14. The detection circuit 15 receives the output from the optical sensor WA. The detection circuit 15 converts signals received from the optical sensors WA into data that can be interpreted by the control circuit 30 and outputs the data to the control circuit 30. The detection circuit 15 of the embodiment is a microcontroller unit (MCU).

FIG. 3 is a circuit diagram illustrating a circuit configuration of the optical sensor WA. The first direction Dx and the second direction Dy in FIG. 3 merely correspond to the directions of the reset control scan lines 5, the readout control scan lines 6, and the signal lines 7, and do not exactly indicate the relative positional relation of the circuit configuration in the optical sensor WA.

As illustrated in FIG. 3, a reset transistor 81, the photodiode 82, a source follower transistor 83, and a readout transistor 85 are provided in the optical sensor WA. In other words, the reset transistor 81, the source follower transistor 83, and the readout transistor 85 are provided correspondingly to one photodiode 82. The transistors included in the optical sensor WA are each configured as an n-type thin-film transistor (TFT). However, each of the transistors is not limited thereto and may be configured as a p-type TFT.

A reference potential VCOM is applied to the anode of the photodiode 82. The cathode of the photodiode 82 is coupled to the gate of the source follower transistor 83 and one of the source and the drain of the reset transistor 81.

The gate of the reset transistor 81 is coupled to the reset control scan line 5. The other of the source and the drain of the reset transistor 81 is supplied with a reset potential VReset. Turning on the reset transistor 81 (into a conducting state) resets the potential of the cathode of the photodiode 82 to the reset potential VReset. The reference potential VCOM is lower than the reset potential VReset. As a result, the photodiode 82 is driven in a reverse-biased manner.

The source follower transistor 83 is coupled between a terminal supplied with an output source potential VPP and the readout transistor 85. The gate of the source follower transistor 83 is coupled to the cathode of the photodiode 82. The gate of the source follower transistor 83 is supplied with a voltage corresponding to a received light intensity of the photodiode 82. As a result, the source follower transistor 83 outputs a potential corresponding to the received light intensity of the photodiode 82 to the readout transistor 85.

The reset potential VReset, the reference potential VCOM, and the output source potential VPP are supplied by the detection circuit 15 to the optical sensor WA based on, for example, electric power supplied via a power supply circuit (not illustrated) coupled to the detection circuit 15, but are not limited to being supplied in this way, and may be supplied in a different way as appropriate.

The readout transistor 85 is coupled between the source of the source follower transistor 83 and the signal line 7. The gate of the readout transistor 85 is coupled to the readout control scan line 6. Turning on the readout transistor 85 outputs, to the signal line 7, the signal output from the source follower transistor 83, that is, the potential corresponding to the received light intensity of the photodiode 82.

In FIG. 3, the reset transistor 81 and the readout transistor 85 each have a single-gate structure. However, the reset transistor 81 and the readout transistor 85 may each have what is called a double-gate structure configured by coupling two transistors in series, or may have a configuration in which three or more transistors are coupled in series. The circuit of one optical sensor WA is not limited to the configuration including the three transistors of the reset transistor 81, the source follower transistor 83, and the readout transistor 85. The optical sensor WA may have a configuration including two transistors, or four or more transistors.

FIG. 4 is a schematic view illustrating a positional relation between the main configuration of the detection device 1 and the object to be detected SUB. In the detection device 1, the light source panel 20 and the sensor panel 10 are provided so as to face each other in the third direction Dz with the object to be detected SUB interposed therebetween. The object to be detected SUB is, for example, a Petri dish in which a culture medium such as an agar medium is formed, but is not limited to this example, and may have any other configuration that transmits the light from the light source panel 20.

A light directivity control element 60 is provided between the object to be detected SUB and the sensor panel 10. The light directivity control element 60 is an optical element that transmits, toward the photodiode 82, components of the light emitted from the light source panel 20 that travel in a direction orthogonal to the sensor panel 10. The light directivity control element 60 is also called collimating apertures or a collimator. Alternatively, the light directivity control element 60 may be configured with a louver or microlenses instead of the collimator.

The first drive circuit 13 is a circuit that drives the reset control scan lines 5 in the detection area SA. The first drive circuit 13 includes a shift register circuit, for example.

In the present disclosure, the first drive circuit 13 sequentially selects the reset control scan lines 5 based on various control signals such as start pulse signals and clock pulse signals supplied from the detection circuit 15, and supplies a reset control signal RST to the selected reset control scan lines 5. In other words, the first drive circuit 13 simultaneously supplies the reset control signal RST to the optical sensors WA arranged in the first direction Dx, and sequentially supplies the reset control signal RST to the optical sensors WA arranged in the second direction Dy. This operation resets the potentials of the photodiodes 82 of the optical sensors WA coupled to the reset control scan lines 5 selected by the first drive circuit 13.

The second drive circuit 14 is a circuit that drives the readout control scan lines 6 in the detection area SA. The second drive circuit 14 includes a shift register circuit, for example.

In the present disclosure, the second drive circuit 14 sequentially selects the readout control scan lines 6 based on the various control signals such as the start pulse signals and the clock pulse signals supplied from the detection circuit 15, and supplies a readout control signal RD to the selected readout control scan lines 6. In other words, the second drive circuit 14 simultaneously supplies the readout control signal RD to the optical sensors WA arranged in the first direction Dx, and sequentially supplies the readout control signal RD to the optical sensors WA arranged in the second direction Dy. This operation reads the potentials of the optical sensors WA coupled to the readout control scan lines 6 selected by the second drive circuit 14.

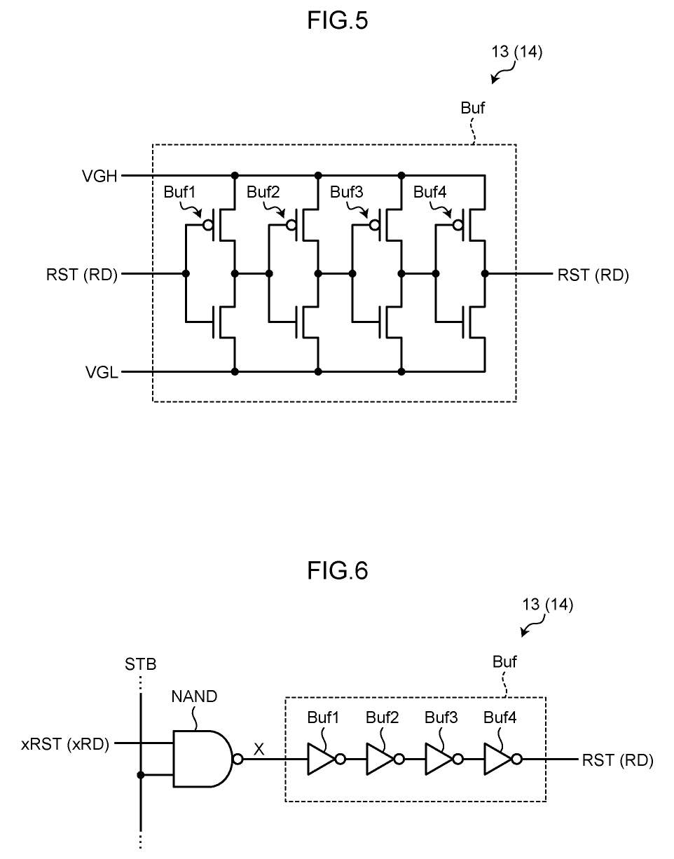

FIG. 5 is a circuit diagram illustrating an example of internal components of the first drive circuit 13 and the second drive circuit 14. FIG. 5 illustrates some of the internal components included in both the first drive circuit 13 and the second drive circuit 14 (hereinafter, also referred to as "drive circuits 13 (14)").

The drive circuits 13 (14) each include a buffer circuit Buf that supplies drive signals (reset control signal RST and readout control signal RD) to the optical sensors WA. FIG. 5 illustrates a configuration obtained by coupling a plurality of inverting buffer circuits Buf1, Buf2, Buf3, and Buf4 in multiple stages. Each of the inverting buffer circuits Buf1, Buf2, Buf3, and Buf4 includes a complementary metal-oxide-semiconductor (CMOS) inverter circuit in which a p-type transistor and an n-type transistor are coupled in series between a first potential VGH and a second potential VGL. The second potential VGL is lower than the first potential VGH. The number of the CMOS inverter circuits included in the buffer circuit Buf is not limited to this configuration.

The first potential VGH is set to a potential that can control the reset transistor 81 and the readout transistor 85 in the optical sensor WA to be on. The second potential VGL is set to a potential that can control the reset transistor 81 and the readout transistor 85 in the optical sensor WA to be off. The first potential VGH and the second potential VGL are supplied by the detection circuit 15 to the optical sensor WA based on, for example, electric power supplied via a power supply circuit (not illustrated) coupled to the detection circuit 15, but are not limited to being supplied in this way, and may be supplied in a different way as appropriate.

The transistors included in the buffer circuit Buf are each configured as a thin-film transistor (TFT). The gate width of the transistors included in the inverting buffer circuit Buf1 is set to 5 μm, for example. The gate width of the transistors included in the inverting buffer circuit Buf2 is set to 20 μm, for example. The gate width of the transistors included in the inverting buffer circuit Buf3 is set to 50 μm, for example. The gate width of the transistors included in the inverting buffer circuit Buf4 is set to 100 μm, for example.

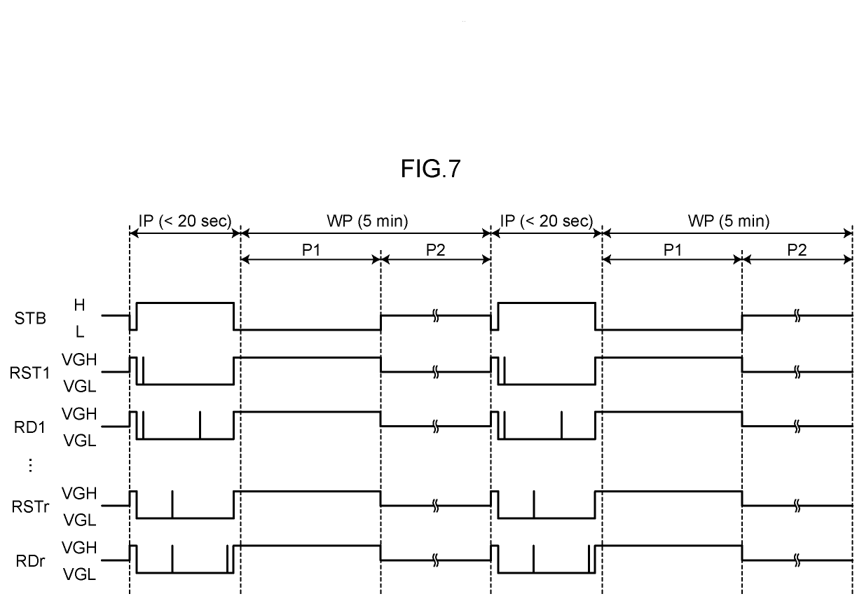

In the detection device 1 according to the embodiment, the control circuit 30 acquires detection values of the optical sensors WA provided in the detection area SA of the sensor panel 10, and repeats an imaging period IP during which an image of the object to be detected SUB located in the detection area SA is captured, and a waiting period WP during which the image of the object to be detected SUB is not captured, at intervals of a predetermined period. This operation can acquire a temporal growth process of a colony in the object to be detected SUB. In the present disclosure, the imaging period IP during which the image of the object to be detected SUB is captured is, for example, 20 seconds or less. In the present disclosure, the waiting period WP during which the image of the object to be detected SUB is not captured is, for example, 5 minutes (refer, for example, to FIG. 7).

In the drive circuits 13 (14) having the configuration described above, if each of the transistors included in the buffer circuit Buf is maintained in an on state during the waiting period when no image of the object to be detected SUB is captured, the threshold voltage (Vth) shifts to the negative side (hereinafter, also referred to as "Vth shift") and current-voltage characteristics may deteriorate, resulting in lower reliability. The following describes specific examples of configurations and operations that can reduce the Vth shift of the thin-film transistor included in the drive circuits 13 (14) having the configuration described above.

FIG. 6 is a block diagram illustrating a configuration example of the drive circuits 13 (14) according to the embodiment. As illustrated in FIG. 6, the drive circuits 13 (14) according to the embodiment have a configuration in which a NOT-AND circuit NAND is provided in the input side of the buffer circuit Buf, and the output potential of the buffer circuit Buf becomes the first potential VGH when the logical value of a standby signal STB is "0". In the present disclosure, the logic control timing of a NOT-AND circuit NAND may be controlled via the detection circuit 15 under the control of the control circuit 30 or may be controlled directly by the control circuit 30. The configuration illustrated in FIG. 6 is an example, but is not limited to this example and can be changed as appropriate.

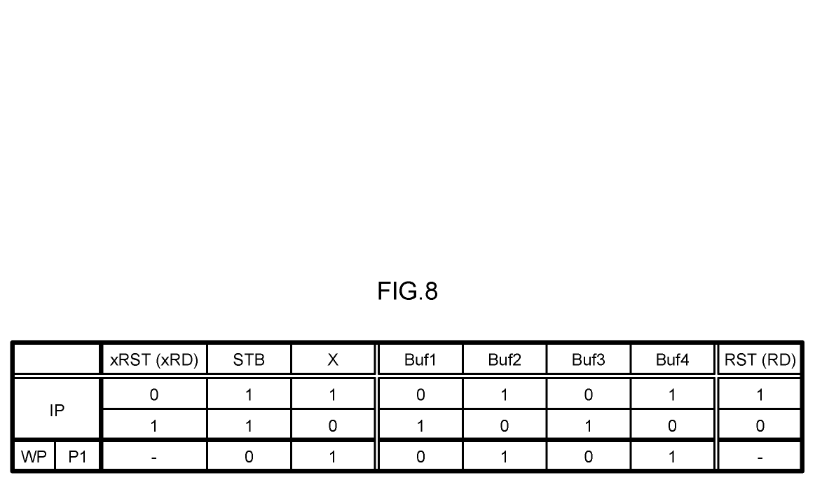

FIG. 7 is a timing diagram illustrating a first example of timing control of the imaging period IP and the waiting period WP of the detection device 1 according to the embodiment. FIG. 8 is a conceptual chart illustrating the logic values of respective parts of the buffer circuit Buf in the first example of the timing control illustrated in FIG. 7.

In the first example of the timing control illustrated in FIG. 7, the control circuit 30 controls the output potential of the buffer circuit Buf to be the first potential VGH during a first period P1 in the waiting period WP.

More specifically, the control circuit 30 sets the logic value of the standby signal STB to "1" during the imaging period IP to enable drive control of the optical sensors WA by the reset control signal RST and the readout control signal RD.

The control circuit 30 sets the logic value of the standby signal STB to "0" in the first period P1. This operation sets an output logic value X of the NOT-AND circuit NAND to "1", the output logic value of the inverting buffer circuit Buf1 to "0", the output logic value of the inverting buffer circuit Buf2 to "1", the output logic value of the inverting buffer circuit Buf3 to "0", and the output logic value of the inverting buffer circuit Buf4 to "1"; and the output potential of the buffer circuit Buf is controlled to be the first potential VGH.

In the present disclosure, the ratio of the imaging period IP to the first period P1 in the waiting period WP is set within the range of 4:6 to 6:4. As a result, the Vth shift of the transistor with its on-control period maintained during the imaging period IP can be recovered in the first period P1 in the waiting period WP. The ratio of the imaging period IP to the first period P1 in the waiting period WP is preferably close to 5:5.

Then, in a second period P2 after the first period P1 in the waiting period WP, the power supply to the buffer circuit Buf is stopped. This operation can prevent each of the transistors included in the buffer circuit Buf from being maintained in the on state, and thus can inhibit acceleration of the deterioration of the characteristics due to the Vth shift of each of the transistors included in the buffer circuit Buf. As described above, the buffer circuit Buf is included in each of the first drive circuit 13 and the second drive circuit 14.

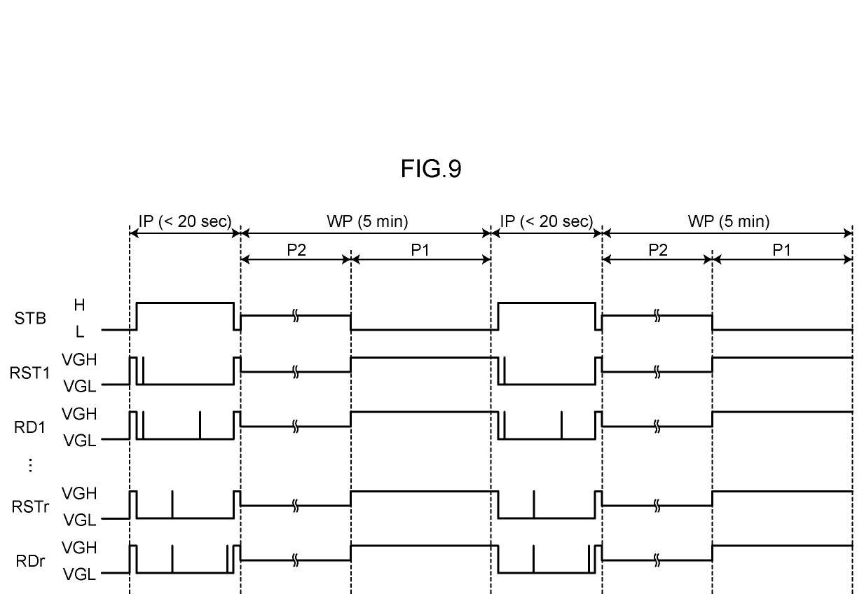

FIG. 9 is a timing diagram illustrating a second example of the timing control of the imaging period IP and the waiting period WP of the detection device 1 according to the embodiment. In the second example of the timing control illustrated in FIG. 9, the first period P1 and the second period P2 in the waiting period WP are swapped with respect to the first example of the timing control illustrated in FIG. 7. In other words, in the second example of the timing control illustrated in FIG. 9, the control circuit 30 stops the power supply to the buffer circuit Buf during the second period P2 in the waiting period WP, and controls the output potential of the buffer circuit Buf to be the first potential VGH during the subsequent first period P1.

Also, in the second example of the timing control illustrated in FIG. 9, in the same way as in the first example of the timing control illustrated in FIG. 7, the ratio of the imaging period IP to the first period P1 in the waiting period WP is set within the range of 4:6 to 6:4, whereby the Vth shift of the transistor with its on-control period maintained during the imaging period IP can be recovered in the first period P1 in the waiting period WP. Also, in the second example of the timing control illustrated in FIG. 9, the ratio of the imaging period IP to the first period P1 in the waiting period WP is preferably close to 5:5 in the same way as in the first example of the timing control illustrated in FIG. 7.

In the second example of the timing control illustrated in FIG. 9, the power supply to the buffer circuit Buf is stopped in the second period P2 before the first period P1 in the waiting period WP. This operation can prevent each of the transistors included in the buffer circuit Buf from being maintained in the on state, and thus can inhibit acceleration of the deterioration of the characteristics due to the Vth shift of each of the transistors included in the buffer circuit Buf included in each of the first drive circuit 13 and the second drive circuit 14, in the same way as in the first example of the timing control illustrated in FIG. 7.

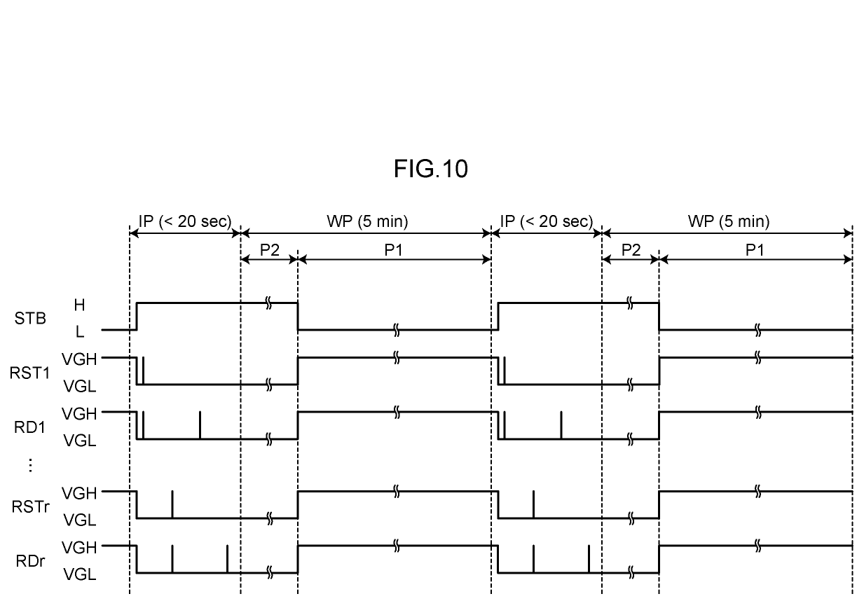

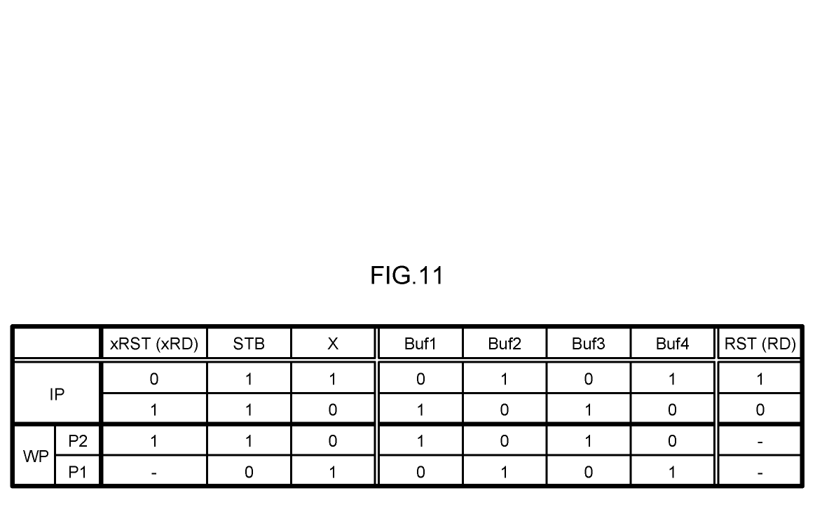

FIG. 10 is a timing diagram illustrating a third example of the timing control of the imaging period IP and the waiting period WP of the detection device 1 according to the embodiment. FIG. 11 is a conceptual chart illustrating the logic values of the respective parts of the buffer circuit Buf in the third example of the timing control illustrated in FIG. 10.

In the third example of the timing control illustrated in FIG. 10, the control circuit 30 controls the output potential of the buffer circuit Buf to be the second potential VGL during the second period P2 in the waiting period WP, and controls the output potential of the buffer circuit Buf to be the first potential VGH during the subsequent first period P1.

More specifically, the control circuit 30 sets the logic value of the standby signal STB to "1" in the second period P2. This operation sets the output logic value X of the NOT-AND circuit NAND to "0", the output logic value of the inverting buffer circuit Buf1 to "1", the output logic value of the inverting buffer circuit Buf2 to "0", the output logic value of the inverting buffer circuit Buf3 to "1", and the output logic value of the inverting buffer circuit Buf4 to "0"; and the output potential of the buffer circuit Buf is controlled to be the second potential VGL.

The control circuit 30 sets the logic value of the standby signal STB to "0" in the first period P1. This operation sets the output logic value X of the NOT-AND circuit NAND to "1", the output logic value of the inverting buffer circuit Buf1 to "0", the output logic value of the inverting buffer circuit Buf2 to "1", the output logic value of the inverting buffer circuit Buf3 to "0", and the output logic value of the inverting buffer circuit Buf4 to "1"; and the output potential of the buffer circuit Buf is controlled to be the first potential VGH.

In the present disclosure, the ratio of a period obtained by summing the imaging period IP and the second period P2 in the waiting period WP to the first period P1 in the waiting period WP is set within the range of 4:6 to 6:4. As a result, in the first period P1 in the waiting period WP, it is possible to recover the Vth shift of the transistor with its on-control period maintained during the period obtained by summing the imaging period IP and the second period P2 in the waiting period WP. The ratio of the period obtained by summing the imaging period IP and the second period P2 in the waiting period WP to the first period P1 in the waiting period WP is preferably close to 5:5.

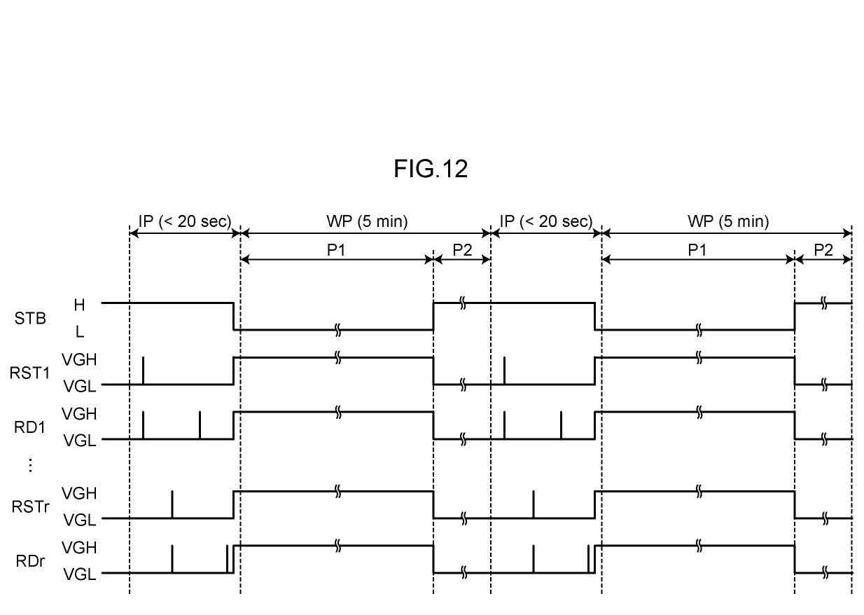

FIG. 12 is a timing diagram illustrating a fourth example of the timing control of the imaging period IP and the waiting period WP of the detection device 1 according to the embodiment. In the fourth example of the timing control illustrated in FIG. 12, the second period P2 and the first period P1 in the waiting period WP are swapped with respect to the third example of the timing control illustrated in FIG. 10. In other words, in the fourth example of the timing control illustrated in FIG. 12, the control circuit 30 controls the output potential of the buffer circuit Buf to be the first potential VGH in the first period P1 in the waiting period WP, and controls the output potential of the buffer circuit Buf to be the second potential VGL during the subsequent second period P2.

Also, in the fourth example of the timing control illustrated in FIG. 12, in the same way as in the third example of the timing control illustrated in FIG. 10, the ratio of the period obtained by summing the imaging period IP and the second period P2 in the waiting period WP to the first period P1 in the waiting period WP is set within the range of 4:6 to 6:4. As a result, in the first period P1 in the waiting period WP, it is possible to recover the Vth shift of the transistor with its on-control period of maintained during the period obtained by summing the imaging period IP and the second period P2 in the waiting period WP. Also, in the fourth example of the timing control illustrated in FIG. 12, the ratio of the period obtained by summing the imaging period IP and the second period P2 in the waiting period WP to the first period P1 in the waiting period WP is preferably close to 5:5 in the same way as in the third example of the timing control illustrated in FIG. 10.

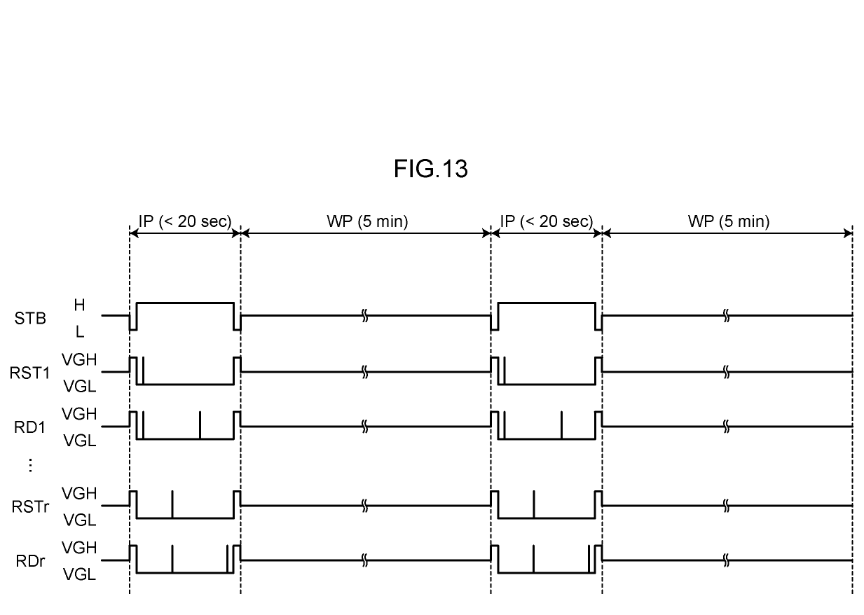

FIG. 13 is a timing diagram illustrating a fifth example of the timing control of the imaging period IP and the waiting period WP of the detection device 1 according to the embodiment.

In the fifth example of the timing control illustrated in FIG. 13, the control circuit 30 stops the power supply to the buffer circuit Buf during the waiting period WP. This operation can prevent each of the transistors included in the buffer circuit Buf from being maintained in the on state during the waiting period WP.

The configurations and operations of the embodiment described above can inhibit the acceleration of the deterioration of the characteristics due to the Vth shift of each of the transistors included in the buffer circuit Buf included in each of the first drive circuit 13 and the second drive circuit 14.

While the preferred embodiment of the present disclosure has been described above, the present disclosure is not limited to such an embodiment. The content disclosed in the embodiment is merely an example, and can be variously modified within the scope not departing from the gist of the present disclosure. Any modifications appropriately made within the scope not departing from the gist of the present disclosure also naturally belong to the technical scope of the present disclosure. At least one of various omissions, substitutions, and changes of the components can be made without departing from the gist of the embodiment described above and the modifications thereof.

What is claimed is:

1. A detection device comprising:
a sensor panel comprising a detection area in which a plurality of optical sensors are arranged in a planar configuration and a drive circuit configured to drive the optical sensors;
a light source configured to emit light to the detection area; and
a control circuit configured to control the sensor panel and the light source to acquire detection values of the optical sensors, and repeat, at intervals of a predetermined period, an imaging period during which an image of an object to be detected located in the detection area is captured and a waiting period during which the image of the object to be detected is not captured, wherein
the drive circuit
comprises a buffer circuit comprising a complementary metal-oxide-semiconductor (CMOS) inverter circuit in which a p-type transistor and an n-type transistor are coupled in series between a first potential and a second potential lower than the first potential, and
is configured to supply drive signals to the optical sensors via the buffer circuit during the imaging period, and
the control circuit is configured to
control an output potential of the buffer circuit to be the first potential during a first period in the waiting period, and
stop power supply to the buffer circuit during a second period different from the first period in the waiting period.

2. The detection device according to claim 1, wherein a ratio of the imaging period to the first period is 4-6. to 4-6..

3. The detection device according to claim 1, wherein
the optical sensors are arranged in a first direction and a second direction different from the first direction, and
the drive circuit is configured to
simultaneously supply the drive signals to the optical sensors arranged in the first direction, and
sequentially supply the drive signals to the optical sensors arranged in the second direction.

4. The detection device according to claim 3, wherein
each of the optical sensors comprises:
a photodiode;
a reset transistor configured to apply a reset potential to a cathode of the photodiode;
a source follower transistor configured to output a signal corresponding to a potential generated by the photodiode; and
a readout transistor configured to read out the signal output from the source follower transistor, and
the drive circuit comprises:
a first drive circuit configured to drive the reset transistor; and
a second drive circuit configured to drive the readout transistor.

5. The detection device according to claim 1, wherein the buffer circuit comprises a plurality of the CMOS inverter circuits.

6. The detection device according to claim 1, comprising a light directivity control element located between the object to be detected and the sensor panel.

7. The detection device according to claim 6, wherein the light directivity control element is a collimator.

8. A detection device comprising:
a sensor panel comprising a detection area in which a plurality of optical sensors are arranged in a planar configuration and a drive circuit configured to drive the optical sensors;
a light source configured to emit light to the detection area; and
a control circuit configured to control the sensor panel and the light source to acquire detection values of the optical sensors, and repeat, at intervals of a predetermined period, an imaging period during which an image of an object to be detected located in the detection area is captured and a waiting period during which the image of the object to be detected is not captured, wherein
the drive circuit
comprises a buffer circuit comprising a complementary metal-oxide-semiconductor (CMOS) inverter circuit in which a p-type transistor and an n-type transistor are coupled in series between a first potential and a second potential lower than the first potential, and
is configured to supply drive signals to the optical sensors via the buffer circuit during the imaging period, and
the control circuit is configured to
control an output potential of the buffer circuit to be the first potential during a first period in the waiting period, and
control the output potential of the buffer circuit to be the second potential during a second period different from the first period in the waiting period.

9. The detection device according to claim 8, wherein a ratio of a period obtained by summing the imaging period and the second period to the first period is 4:6 to 6:4.

10. The detection device according to claim 8, wherein
the optical sensors are arranged in a first direction and a second direction different from the first direction, and
the drive circuit is configured to
simultaneously supply the drive signals to the optical sensors arranged in the first direction, and
sequentially supply the drive signals to the optical sensors arranged in the second direction.

11. The detection device according to claim 10, wherein
each of the optical sensors comprises:
a photodiode;
a reset transistor configured to apply a reset potential to a cathode of the photodiode;
a source follower transistor configured to output a signal corresponding to a potential generated by the photodiode; and
a readout transistor configured to read out the signal output from the source follower transistor, and
the drive circuit comprises:
a first drive circuit configured to drive the reset transistor; and
a second drive circuit configured to drive the readout transistor.

12. The detection device according to claim 8, wherein the buffer circuit comprises a plurality of the CMOS inverter circuits.

13. The detection device according to claim 8, comprising a light directivity control element located between the object to be detected and the sensor panel.

14. The detection device according to claim 13, wherein the light directivity control element is a collimator.

15. A detection device comprising:
a sensor panel comprising a detection area in which a plurality of optical sensors are arranged in a planar configuration and a drive circuit configured to drive the optical sensors;
a light source configured to emit light to the detection area; and
a control circuit configured to control the sensor panel and the light source to acquire detection values of the optical sensors, and repeat, at intervals of a predetermined period, an imaging period during which an image of an object to be detected located in the detection area is captured and a waiting period during which the image of the object to be detected is not captured, wherein
the drive circuit
comprises a buffer circuit comprising a complementary metal-oxide-semiconductor (CMOS) inverter circuit in which a p-type transistor and an n-type transistor are coupled in series between a first potential and a second potential lower than the first potential, and
is configured to supply drive signals to the optical sensors via the buffer circuit during the imaging period, and
the control circuit is configured to stop power supply to the buffer circuit during the waiting period.

16. The detection device according to claim 15, wherein
the optical sensors are arranged in a first direction and a second direction different from the first direction, and
the drive circuit is configured to
simultaneously supply the drive signals to the optical sensors arranged in the first direction, and
sequentially supply the drive signals to the optical sensors arranged in the second direction.

17. The detection device according to claim 16, wherein
each of the optical sensors comprises:
a photodiode;
a reset transistor configured to apply a reset potential to a cathode of the photodiode;
a source follower transistor configured to output a signal corresponding to a potential generated by the photodiode; and
a readout transistor configured to read out the signal output from the source follower transistor, and
the drive circuit comprises:
a first drive circuit configured to drive the reset transistor; and
a second drive circuit configured to drive the readout transistor.

18. The detection device according to claim 15, wherein the buffer circuit comprises a plurality of the CMOS inverter circuits.

19. The detection device according to claim 15, comprising a light directivity control element located between the object to be detected and the sensor panel.

20. The detection device according to claim 19, wherein the light directivity control element is a collimator.
